(19) United States
(12) Patent Application Publication
(10) Pub. No.: US 2017/0287259 A1
(43) Pub. Date: Oct. 5, 2017

(54) Electricity Smart Meters And Electricity Distribution Systems

(71) Applicant: Power Pay, Inc., Fort Collins, CO (US)

(72) Inventor: Andrew Joshua March, Fort Collins, CO (US)

(73) Assignee: Power Pay, Inc., Fort Collins, CO (US)

(21) Appl. No.: 15/470,749

(22) Filed: Mar. 27, 2017

Related U.S. Application Data
(60) Provisional application No. 62/316,904, filed on Apr. 1, 2016.

(51) Int. Cl. G07F 15/00; G06Q 20/26; G01R 21/00; G01R 21/133; H02J 3/14; G06Q 50/06

(52) U.S. Cl. CPC G07F 15/003; H02J 3/14; G06Q 50/06; G01R 21/007; G01R 21/1333; G06Q 20/26

(57) ABSTRACT

A smart meter can include a plurality of relays for providing power to corresponding power lines, each of the plurality of relays associated with a customer's account and a management system storing customer account information and controlling and tracking a power usage for each of the plurality of relays, and based on the power usage and the corresponding customer account information turning on or off power to the corresponding power line.

This U.S. Non-Provisional Patent Application claims the benefit of U.S. Provisional Patent Application No. 62/316,904, filed Apr. 1, 2016, hereby incorporated by reference herein.

### I. FIELD OF THE INVENTION

A smart meter can include a plurality of relays for providing power to corresponding power lines, each of the plurality of relays associated with a customer's account and a management system storing customer account information and controlling and tracking a power usage for each of the plurality of relays, and based on the power usage and the corresponding customer account information turning on or off power to the corresponding power line.

### II. SUMMARY OF THE INVENTION

Electricity smart meters (“meters”) and electricity distribution systems are described. The described meters can enable multiple consumers to be connected to an electric grid through a single meter with certain local level control. A distributor can connect multiple consumers to an electrical grid through a single meter while providing local, independent control of the power supply at the meter level to each of the multiple consumers.

A smart meter can include a plurality of relays for providing power to corresponding power lines, each relay associated with a customer's account; and a management system controlling each relay of the plurality of relays independently. The management system can store customer account information and track, for each of the plurality of relays, a power usage for the customer's account and, based on the power consumption and the corresponding customer account information, turn on or off power to the corresponding power line.

A method facilitating distribution can include monitoring power usage of each of a plurality of power lines connected to a corresponding one of a plurality of relays at the meter, each power line corresponding to a customer account, checking a credit level of a customer account, wherein the credit level is an amount of money or resources present in the specific customer's account, and responsive to the credit level turning on or off a relay at the meter associated with the specific customer account.

### III. BRIEF DESCRIPTION OF THE DRAWINGS

FIG. 1A illustrates a particular embodiment of an electricity smart meter.

FIG. 1B illustrates a particular embodiment of a management system.

FIG. 2 illustrates a particular embodiment of a process flow diagram for power usage control that may be carried out by a management system.

FIG. 3 illustrates a particular embodiment of a process flow diagram for power usage control that may be carried out by a management system.

FIG. 4 illustrates a particular embodiment of an electricity distribution system in which electricity smart meters and electricity distribution system may be employed.

FIG. 5 illustrates a front view of a particular embodiment of an electricity smart meter.

FIG. 6 illustrates a side view of a particular embodiment of an electricity smart meter and electricity distribution system.

FIG. 7 illustrates a side interior view of a particular embodiment of an electricity smart meter and electricity distribution system.

FIG. 8 illustrates a front interior view of a particular embodiment of an electricity smart meter and electricity distribution system.

FIG. 9 illustrates a particular embodiment of a logic board.

### IV. DETAILED DESCRIPTION OF THE INVENTION

Electricity smart meters 100 (“meters”) and electricity distribution systems 1 are described. The meter 100 can include a management system 101 and a plurality of relays 105 associated with specific customer accounts 203. The plurality of relays 105 can provide power 2 to corresponding power lines 3 (e.g., 3a, 3b, 3c, 3d, 3e, 3f, 3g, 3h) controlled by the management system 101. The management system 101 can determine power usage 4 of each power line 3 by, in particular embodiments, using current sensors 5 and voltage sensors 6. The management system 101 locally tracks a value of a customer account 203 and, based on the value of the customer account 203, the account type, and the determined power usage 4 of the power line 3 for the customer account 203, allows access to electricity for that customer via the corresponding one of the plurality of relays 105 at the meter 100.

The management system 101 can control each relay 105 independently. The management system 101 can manage multiple customer accounts 203 and automatically shut off one of the plurality of relays 105 associated with a specific customer account 203 without necessitating a shutdown of the whole meter 100. The management system 101 can also maintain control of each of the plurality of relays 105 in the event of an interruption of communication with a central system 7.

The installation and implementation of both the described meter 100 and management system 101 can provide wireless Supervisory Control and Data Acquisition (SCADA) infrastructure with Advanced Metering Infrastructure (AMI) features.

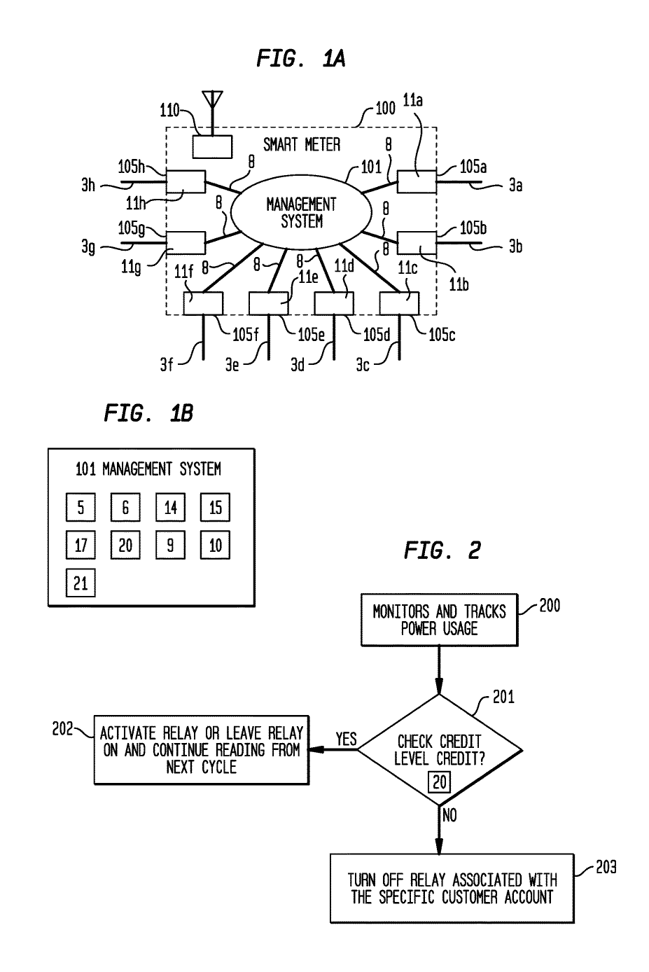

FIG. 1A illustrates a particular embodiment of a meter 100. Referring to FIG. 1A, a meter 100 can include a management system 101 and a plurality of relays 105 (e.g., 105a, 105b, 105c, 105d, 105e, 105f, 105g, 105h) controlled by the management system 101. Each of the plurality of relays 105 can provide power 2 to a corresponding power line 3 that supplies power 2 to a customer. The management system 101 can associate a customer account 203 for each of the plurality of relays 105. There can be a 1:1 ratio of relays 105 to management system connections 8. Thus, the number of relays 105 at a meter 100, and by extension, the number of customer accounts 203 supported by a single meter 100, may be constrained by the number of connections 8 that the management system 101 within the meter 100 can provide. In some particular embodiments, certain portions of the management system 101 can be exchangeable to provide more or fewer connections 8, and, by extension, support more or fewer relays 105 and associated customer accounts 203.

In particular embodiments, the management system 101 can include a processing system 9 and a storage system 10. The management system 101 can further include a plurality of counters 11 (one for each customer account 203) and at least one current sensor 5 and at least one voltage sensor 6 to facilitate detection of power usage 4 for each power line 3.

By way of illustration only, a meter 100 can have one voltage sensor 6 and a plurality of current sensors 5 (one for each of the plurality of relays 105). The current sensors 5 can be units that may be bundled into a single removable unit along with the plurality of relays 105. A “counter” 11 (counters, 11a, 11b, 11c, 11d, 11e, 11f, 11g, 11h) in the meter 100 can include a current sensor 5 for the customer account 203, or just use an output of the current sensor 5 to multiply that current value 12 by a voltage value 13 received from the output of the one voltage sensor 6 of the meter 100.

Referring to FIG. 1B, in particular embodiments, the management system 101 can include a processing system 9 which may include one or more processors 14 and/or other circuitry that retrieves and executes software from a local storage system 10 or memory element 15. The processing system 9 can be implemented within a single processing device in particular embodiments. In further particular embodiments, the processing system 9 can be distributed across multiple processing devices or sub-systems that cooperate in executing program instructions. The processing system 9 can be disposed on a logic board 16 in the meter 100. Non-limiting examples of a processing system 9 include general purpose central processing units, application specific processors, and logic devices, as well as any other type of processing device, combinations, or variations thereof. In certain embodiments, one or more digital signal processors 14 (DSPs) may be included as part of the computer hardware of the system in place of or in addition to a general purpose CPU. Field programmable logic arrays (FPGAs) and application specific integrated circuits (ASICs) may be used as well. In particular embodiments, the management system 101 can further include a closed programmed microprocessing unit, where the software can be considered firmware.

The storage system 10 can include any storage media 17 readable by the processing system 9 and capable of storing software and data. More than one storage medium 17 can be included as part of the management system 101. Storage media 17 can include volatile and nonvolatile, removable and non-removable storage media 17 implemented in any method or technology for storage of information, such as computer readable instructions, data structures, program modules, or other data. The storage system 10 can include additional elements, such as a controller, capable of communicating with the processing system 9.

The meter 100 can further include a communication system 110 (e.g., antenna(s) 18 and transceiver(s) 19) to permit the management system 101 to wirelessly communicate with at least a central system 7 of a distributor. The communication module 110 may provide cellular (e.g., GSM), radio frequency, BLUETOOTH, and/or WI-FI communication.

The management system 101 can receive customer account payment information 20, via the communication system 110, from a central system 7. The management system 101 can store the customer account payment information 20 for all users in the storage system 10 of the management system 101. The customer account payment information 20 can include, but is not limited to, a customer account identifier 21 and values including: a relay address, a current sensor address, an instantaneous power usage 4, an accumulated power usage 4, a remaining credit 21, and any other meter-level related information. Once the customer account payment information 20 is received, the management system 101 can manage the connections 8 without interference from the central system 7.

In particular embodiments, the meter 100 can use a microcontroller as the processing system 9 of the management system 101, which can be connected to a wireless transmitter of the communication system 110 that receives payment information when a customer adds credit 21 to their account. Using a customer code, the microcontroller can store the customer account information 20 and allows access to power 2 by controlling a one-way electronic relay (e.g., the plurality of relays 105) corresponding to that customer account 203. Since there can be a plurality of relays 105 connected to the microcontroller's logic board 16, many connections can be made available to access points through the use of a single meter 100.

By way of illustration, the management system 101 can locally track and monitor the power usage 4 for each customer via the power line 3 associated with the customer account 203. A 1:1 ratio of relays 105 to customer accounts 203 can enable the management system 101 to have independent control of each of the plurality of relays 105 even in the event of an interruption of communication with the central system 7. In particular embodiments, the management system 101 can track, for each of the plurality of relays 105, a power usage 4 for a customer account 203 through the use of the voltage sensor 6 and current sensor 5. The management system 101 can calculate the power 2 consumed by a customer by using the voltage value 13 and current value 12 of the power line 3 over time. The amount of power 2 used can be permitted based on the value indicated as part of the customer account payment information 20. By way of example only, at each sampling of the power 2 off the line, the power 2 used can be multiplied by a rate per unit of power 2 that can be assigned to the customer. That value can be subtracted from the value stored and associated with the customer account 203. Then, should the outcome of that subtraction be zero or below, the relay 105 associated with the customer account 203 can be disabled (turned off).

Now referring to FIG. 2, the management system 101 can monitor and track power usage 4 of each of a plurality of power lines 3 connected to a corresponding plurality of relays 105 at the meter 100. Each power line 3 can further correspond to a specific customer account 203. For a specific customer account 203, the management system 101 can check the credit level. If the specific customer account 203 has positive credit, the management system 101 can activate the relay 105 or leave the relay 105 on and continue reading for the next cycle. The management system 101 can turn off the relay 105 associated with the specific customer account 203 if the customer account 203 has negative credit.

In further particular embodiments, an accelerometer 22 can be included in the meter 100 to enable the management system 101 to check for movement or tilt and send an alert 23. The alert 23 may allow the distributor to become aware of any cases of tampering in the meter 100.

In one particular method of use, multiple connections 8 to customers can be accomplished through a single meter 100 located near the customers. Multiple economic sectors (e.g., residential, business, industrial) can have connections 8 to a single meter 100. The meter 100 (e.g., via a logic board 16/processing system 9) can further be programmed to include multiple electricity rates, where the appropriate rate can be associated with the one of the plurality of relays 105 connected to the individual customer.

In particular embodiments, the management system 101 can disable certain customer account 203s at certain times of the day in order to prevent system overload or surges. The management system 101 can check the specific account type, or other information pertinent to the customer account 203. in order to determine which customer account 203 to disable. The management system 101 can select a customer account 203 and disable their electricity during certain times related to distributor use restrictions, i.e. high power usage 4 activities.

By way of illustration only, the management system 101 can disable certain customer account 203s in one of two ways. The first disabling can be based on time, in anticipation of load peaks and the second disabling can be an instantaneous response turning off power 2 when the load begins to spike towards the current production capacity. The specific account types that can be disabled can be medium-voltage to high-voltage, high consumption commercial accounts although the invention is not so limited. The management system 101 can identify and disable accounts locally and is able to independently control each of the plurality of relays 105. The management system 101 can carry out the turning on and off power 2 in the instance of a loss of communication with the central system 7 or a loss of the power supply. Indeed, the management system 101 can carry out process flow 200 whether or not there is communication between the central system 7 and the meter 100.

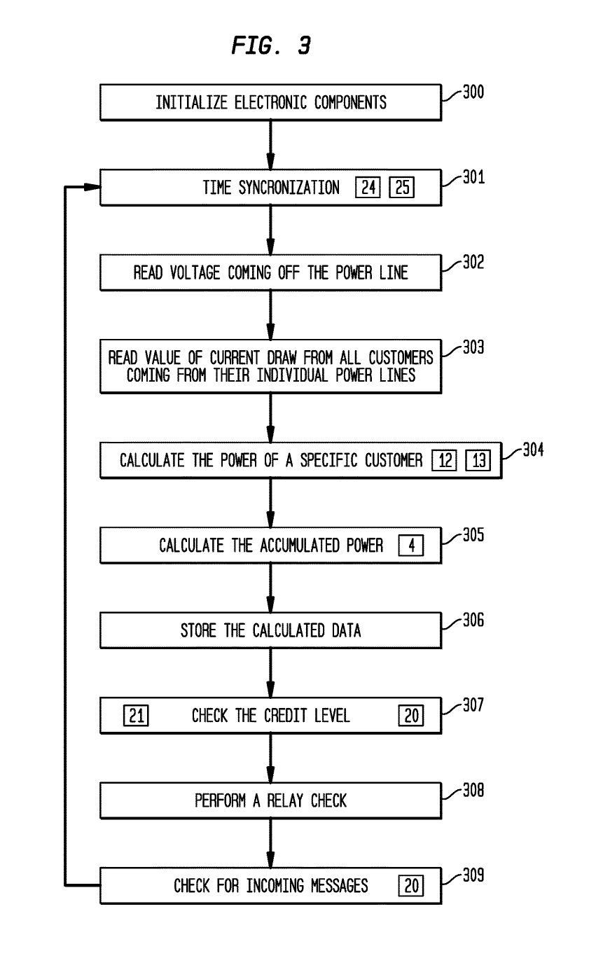

Now referring to FIG. 3, the process flow can begin, upon receiving electricity from the grid, by initializing electronic components 300. The electronic components can include a relay 105, initialized as off, a counter 11, a timer 24, and a clock 25. The management system 101 can, but need not necessarily, perform a time synchronization 301. The management system 101 can read the voltage value 13 coming off of the power line 302. Additionally, the management system 101 can read the current value 12 drawn from all of the customers from their individual power lines 303. After receiving the voltage value 13 and the current value 12, the management system 101 can calculate the power for a specific customer 304. When the management system 101 has the power 2, it can then calculate the power 2 consumed since the last sampling by multiplying the power 2 by the time elapsed since the last read 305. The management system 101 then can store the calculated data 306.

The management system 101 can perform a credit level check 307. The credit level, or amount of credit 21, can be checked by comparing a customer's remaining credit based on how much power 2 the customer has consumed or the customer's accumulated power usage 4. A customer's credit level, or amount of credit 21, refers to the amount of money or resources present in their account. A customer can cause an alert 26 to be sent to the customer's device 27 if a customer's credit level decreases below a certain amount that can, but need not necessarily, be determined by the customer. The alert 26 can be sent to the customer at the credit check if the management system 101 is GSM enabled. However, if the management system 101 is not GSM enabled, the alert 26 can be sent when a customer database update occurs at the central system 7.

In response to the credit check, the management system 101 can perform a relay check 308. If the customer's credit 21 is at or below zero, the management system 101 can turn the relay 105 off If the customer's credit 21 is above zero, the management system 101 can turn the relay 105 on, or keep the relay 105 on, and start reading measurements from the beginning of the following cycle. Further, the management system 101 can check for any incoming messages 309. For example, if the management system 101 is GSM enabled, the management system 101 can check for any received SMS messages or other type of messages that serve as instructions to the management system. Then the process flow can loop back to the time synchronization step.

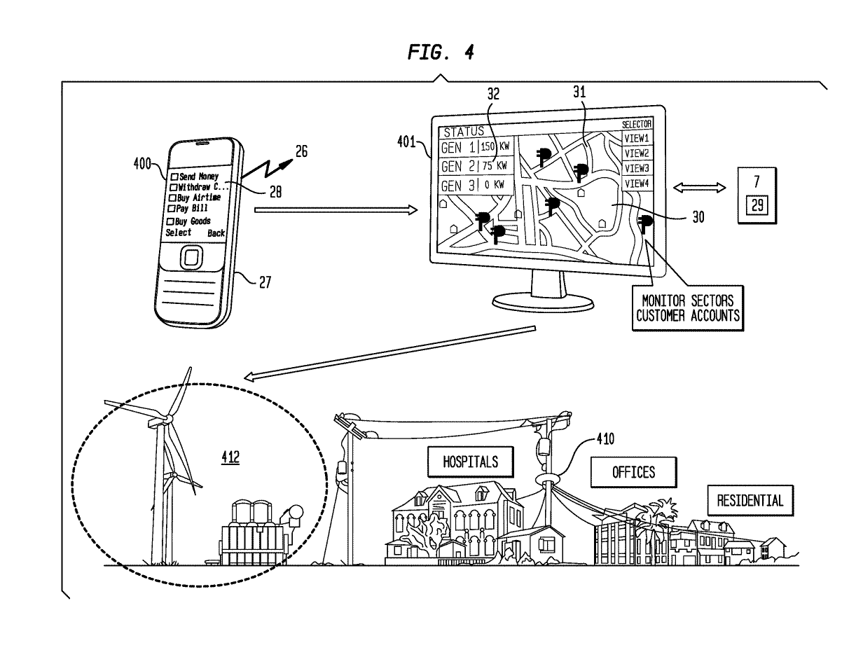

Now referring to FIG. 4, a customer can, but need not necessarily send a mobile payment 28 to the distributor via a mobile phone 400, the distributor having an account with the mobile carrier so that customers making payments 28 in this manner would be able to send payment 28 to the distributor. The mobile carrier can provide payment 28 on behalf of a customer to the distributor, which manages payments 28 at a central system 7.

The central system 7 can maintain a database 29 with the customer's information. The central system 7 can receive and verify the mobile payment 28 and associate the payment 28 with a particular customer account 203. The customer account 203 can be identified by a unique account ID or phone number. The central system 7 sends the information related to the payment 28, via a wireless transmission, to the meter 100.

The central system 7 can monitor sectors and corresponding power usage 4. A display 30, a graphical user interface 401 generated by software running at the central system 7, can present a map of meters 100 and power sources 412. If a distributor selects a meter 100, the distributor can view the customer accounts 203 and corresponding information associated with that particular meter 100. The sectors 31 can be arranged according to a power grid 32 and the various power resources 412 and meters 100 forming the grid. The meter 100 can communicate with the central system 7 and can be controlled using a user database control software used by the grid operator from the central system 7. By interconnecting the meters 100 across a city and separating the access points as sectors 31, energy theft can be detected by determining the physical distance between two meters 100 and their relative distance from the power source.

The meter 100 can be capable of revenue-grade and near revenue grade metering and storing of customer information. The meter 100 can store the account information received from the central system 7 (e.g., regarding payment) and can track the power usage 4 on the lines for each customer account 203.

### EXAMPLE

The electronic smart meter 100 and electricity distribution system 1 includes:
at least 1 electronic relay 105;
at least 1 power unit counter, one for each aforementioned relay 105, including a current sensor 5 and voltage sensor 6;
1 real time clock (RTC) 25;
1 logic board 16;
1 microprocessing chip;
1 backup battery;
1 memory module;
1 240-480 Volt→5V/3.3V, Step-down transformer (optional);
1 High voltage (i.e. 20 kV) to 240 V transformer (optional);
at least 1 communications/transmission module (GSM, BLUETOOTH, WI-FI, etc.).

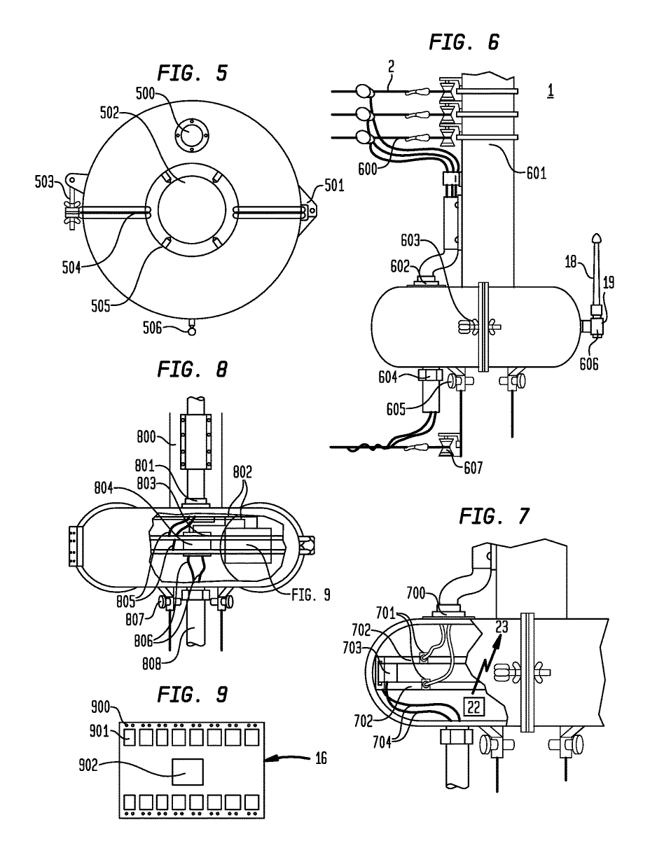

FIG. 5 illustrates a front view of a particular embodiment of an electricity smart meter 100. The elements of FIG. 5 are listed below:

500—Input from transmission lines, +, −, GND.

501—Hinge mechanism for opening the meter 100.

502—Utility pole.

503—Latching mechanism for closing, locking and securing the meter 100.

504—Rubber, waterproof gasket.

505—Fastening screws to the utility pole.

506—Wireless transmission antenna.

FIG. 6 illustrates a side view of a particular embodiment of an electricity smart meter 100 and electricity distribution system 1. The elements of FIG. 6 are listed below:

600—High-voltage transmission lines.

601—Utility pole.

602—Waterproof, securing mechanism for attaching the transmission lines to the meter 100.

603—Latching mechanism for closing, locking and securing the meter 100.

604—Waterproof, securing mechanism for attaching the output lines to the customer.

605—Fastening mechanism to secure the meter 100 to the utility pole.

606—Wireless transmission antenna.

607—Cable fastener to the utility pole for transmission to consumers.

FIG. 7 illustrates a side interior view of a particular embodiment of an electricity smart meter 100 and electricity distribution system 1. The elements of FIG. 7 are listed below:

700—Waterproof, securing mechanism for attaching the transmission lines to the meter 100.

701—Wired input attachments to transformer, and subsequent relay 105 and counting modules via the rail.

702—Wired rail for mounting relay 105s and power unit counting modules.

703—A relay 105 and power unit counting module connected to customer output.

704—Output transmission lines from the relay 105 and power unit counting module to the customer.

FIG. 8 illustrates a front interior view of a particular embodiment of an electricity smart meter 100 and electricity distribution system 1. FIG. 8 includes a view of the logic board 16.

The elements of FIG. 8 are listed below:

800—Transmission line attachment to utility pole.

801—Waterproof, securing mechanism for attaching the transmission lines to the meter 100.

802—Data control connections from the relay 105 and power unit counting module to the logic board 16, these will be wired for each logic board 16 along or underneath the inside rail attaching the relay 105.

803—Wired rail for mounting relay 105 and power unit counting modules.

804—Relay/power unit counting module.

805—Wired input attachments to transformer, and subsequent relay 105 and counting modules via the rail.

806—Output transmission lines from the relay 105 and power unit counting module to the customer.

807—Fastening mechanism to secure the meter 100 to the utility pole.

808—Output transmission lines from the relay 105 and power unit counting module to the customer.

FIG. 9 illustrates a particular embodiment of a logic board 16. The elements of FIG. 9 are listed below:

900—Copper pins as data control connections from the relay 105 and power unit counting module to the logic board 16, these will be wired for each logic board 16 along or underneath the inside rail attaching the relay 105s.

901—Integrated circuit and microchip configuration including:
1 real time clock (RTC) 25;
1 logic board 16;
1 backup battery;
1 memory module;
1 240-480 Volt→5V, Step-down transformer (optional);
at least 1 communications/transmission module (GSM, BLUETOOTH, WI-FI, etc.).
902—Microprocessing chip, ATMEL Mega2560 or similar.

All aforementioned components can be assembled on, connected to, or centered around the logic board 16 and can controlled through control software.

As can be easily understood from the foregoing, the basic concepts of the present invention may be embodied in a variety of ways. The invention involves numerous and varied embodiments of electricity smart meters and electricity distribution systems and methods for making and using such electricity smart meters and electricity distribution systems including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “credit check” should be understood to encompass disclosure of the act of “checking credit”—whether explicitly discussed or not—and, conversely, were there effectively disclosure of the act of “checking credit”, such a disclosure should be understood to encompass disclosure of a “credit check” and even a “means for checking credit.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term in “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the electricity smart meters and electricity distribution systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An electricity distribution system, comprising:
a meter including:
a plurality of relays correspondingly electrically coupled to a plurality of power lines; and
a management system communicatively coupled to each of said plurality of relays, said management system operable to monitor electrical power usage of each of said plurality of power lines correspondingly connected to said plurality of relays;
a communication system communicatively coupled to said management system; and
a central system communicatively coupled to said communication system, said central system transmitting customer account payment information of each a plurality of customer accounts to said communication system;
said management system associating each one of said plurality of customer accounts to a corresponding one of said plurality of relays, said management system controlling access to electrical power based on said customer account payment information transmitted from said central system.

2. The system of claim 1, wherein said management system further comprises a management system processor communicatively coupled to a management system memory module, said management system memory module stores said customer account payment information, said management system capable of operating independent of said central system.

3. The system of claim 2, wherein said management system memory element further contains a management program including one or more management system controllers executable to turn each one of said plurality of relays on or off based on said customer account payment information stored in said memory module.

4. The system of claim 3, wherein said one or more management system controllers further comprise a plurality of counters, each of said plurality of counters associated with one of said plurality of power lines, each of said plurality of counters including at least one current sensor and at least one voltage sensor, said at least one voltage sensor measuring a voltage value and said current sensor measuring a current value of one of the corresponding said plurality of power lines, said counter calculating said power usage of one of the corresponding said plurality of power lines as the product of said voltage value and said current value over a period of time.

5. The system of claim 4, wherein said one or more management system controllers further function to:
identify an electricity rate associated with each one of said plurality of customer accounts;
calculate a cost of said power usage of each one of said plurality of power lines based on said electricity rate associated with each of said plurality of customer accounts; and
compare said cost of said power usage of each one of said plurality of power lines to an amount of credit in each related customer account.

6. The system of claim 5, wherein said electricity rate further comprises a plurality of electricity rates stored in said memory module of said management system, each of said plurality of customer accounts capable of being associated with one or more of said plurality of electricity rates.

7. The system 6, wherein said one or more management system controllers further executable to calculate said amount of credit based on customer account payment information communicated from said central system.

8. The system of claim 7, wherein said one or more management system controllers further executable to turn off each one of said plurality of relays associated with said customer account if said cost of said power usage equals or exceeds said amount of credit in said customer account.

9. The system of claim 8, wherein said one or more management system controllers further executable to generate an alert receivable by a customer device when said amount of credit has a value equal to or less than a predetermined quantity of said amount of credit.

10. The system of claim 9, wherein said one or more management system controllers further executable to turn off one or more of said plurality of relays based on electricity rate categories associated with one or more of said plurality of customer accounts within a pre-selected time period.

11. The system of claim 10, wherein said one or more management system controllers further executable to turn off one or more of said plurality of relays based on electricity rate categories associated with one or more of said plurality of customer accounts in response to exceeding a pre-selected power load.

12. The system of claim 11, wherein said customer account payment information communicated from said central system is selected from the group consisting of: a customer account identification, a relay address, a current sensor address, a power consumption, an amount of credit, an electricity rate, or combinations thereof.

13. The system of claim 12, wherein said central system includes one or more central processing units including a central system processor communicatively coupled to a central system memory element, said central system memory element containing a central system program executable to:
accept a payment for a customer account;
pair said payment with said customer account;
add said payment to said customer account; and
transmit notice of said payment to said management system.

14. The system of claim 13, wherein said central system receives payments made on behalf of said plurality of customer accounts.

15. The system of claim 12, wherein said central processing system further comprises a database control program executable to:
define a plurality of sectors; and
match said meter to one of said plurality of sectors.

16. The system of claim 15, wherein database control program further executable to depict a graphical user interface on a display surface, said graphical user interface depicting:
a map divided into said plurality of sectors;
a location of each said meter or a location of each power source within each of said plurality of sectors.

17. The system of claim 16, wherein said database control program further executable to:
to monitor each of said meters in said sector; and
turn on or turn off each one of said plurality of relays independent of said management system.

18. The system of claim 17, wherein said meter further comprises an accelerometer which detects movement of said meter, said accelerometer communicatively coupled to said management system.

19. The system of claim 18, wherein said management system program further executable to generate an alert to said central system when said accelerometer detects movement of said meter.

20-48 (canceled).
